(19) United States
(12) Patent Application Publication
(10) Pub. No.: US 2017/0075433 A1
(43) Pub. Date: Mar. 16, 2017

(54) Optical Projection Keyboard and Mouse

(71) Applicant: Beijing Jiatuosi Technology Co., Ltd., Beijing (CN)

(72) Inventors: Mingxin Hou, Haerbin (CN); Yunpeng Gao, Haerbin (CN)

(21) Appl. No.: 15/190,509

(22) Filed: Jun. 23, 2016

(30) Foreign Application Priority Data
Sep. 12, 2015 (CN) 201510576933.X

(51) Int. Cl. G06F 3/03; G06F 3/02; G06F 3/038; G06F 3/0354

(52) U.S. Cl. CPC G06F 3/0317; G06F 3/03543; G06F 3/021; G06F 3/038

(57) ABSTRACT

An optical projection keyboard and mouse includes an optical projection hardware module for generating an optical projection keyboard zone and an optical projection mouse zone; an optical projection keyboard zone for achieving the functions of the keyboard; an optical projection mouse zone for achieving the functions of the mouse. The design scheme set forth is characterized by easy carrying, long service life, independent operation and capability of being embedded into other devices.

### CROSS-REFERENCE TO RELATED APPLICATIONS

The present application claims the benefit of Chinese Patent Application No. 201510576933.X filed on Sep. 12, 2015, the contents of which are hereby incorporated by reference.

### FIELD OF THE INVENTION

The invention relates to an optical projection keyboard and mouse, in particular to a device and a method achieving input functions of the keyboard and operation functions of the mouse via optical projection.

### BACKGROUND

The keyboard and mouse have been widely used and popularized as input devices. The functions of the traditional keyboard and mouse are commonly achieved through physical ways, i.e., the input operations are achieved based on the keyboard entity and the mouse entity.

The keyboard inputting usually has multiple modes as inputting through knocking the keys mechanically, inputting through the simulated keyboard on a phablet and inputting through optical projection for laser projection keyboards, etc. The operation of a mouse is usually achieved by controlling a mouse entity, or using the touch tablet or the TrackPoint for a laptop.

The currently common-used keyboard inputting or mouse inputting is mainly achieved by the physical operation of an entity; however, the achieving mode based on the physical operation of an entity needs to rely on a physical input device, which has the disadvantages that it may have a certain size, a certain weight and a limited service life for mechanical knocking.

### SUMMARY OF THE INVENTION

The invention provides a method to achieve the projection keyboard and mouse controlling based on optical projection, which achieves the functions of the keyboard and mouse not relying on a physical entity but an optical projection device, characterized by easy carrying, long service life, independent operation and capability of being embedded into other devices.

The present invention provides an optical projection keyboard and mouse, includes an optical projection hardware module for generating an optical projection keyboard zone and an optical projection mouse zone; an optical projection keyboard zone for achieving the functions of the keyboard; an optical projection mouse zone for achieving the functions of the mouse;

Further, a keyboard generated in the optical projection keyboard zone includes a regular alphabetical keyboard, a numeric keyboard, a shortcut keyboard of F* keys or a customized keyboard.

Further, a user can achieve the control function of the mouse by moving the fingertips in the optical projection mouse zone.

Further, a user can achieve the control function of the mouse through multi-task operation with multiple fingers in the optical projection mouse zone.

Further, the positions of the optical projection keyboard zone and the optical projection mouse zone are interchangeable.

Further, a user can knock the keyboard to input in the optical projection keyboard zone and click the mouse to control in the optical projection mouse zone independently or synchronously.

Further, a user can knock the keyboard to input in the optical projection keyboard zone and click the mouse to control in the optical projection mouse zone independently or synchronously.

Further, the optical projection hardware module comprises:

a projector for generating the optical projection keyboard zone and the mouse zone;

a laser device for emitting invisible light to the operating fingertip of the user;

an image collector for receiving the reflected light of the operating fingertip of the user and collecting the operating position of the fingertip of the user;

a processor for receiving the data transferred by the image collector and processing and identifying the data;

a power supply unit for supplying power to each module in the optical projection hardware module;

an interface module for achieving connections with other modules.

Further, the image collector is a camera or a sensor.

Further, the processor is an ARM chip, a SCM chip, a DSP chip, a FPGA chip, an Intel CPU chip or a self-designed programmable chip.

Further, the interface module provides a USB port, a SPI port, a serial port, an I2C port or an Ethernet port.

Further, the optical projection hardware module is to achieve the functions of the optical projection keyboard and mouse through operating independently or being embedded into other devices.

On the other hand, a method for using the optical projection keyboard and mouse, including:

generating an optical projection keyboard zone and an optical projection mouse zone by an optical projection module;

pressing the optical projection keys by a user fingertips in the optical projection keyboard zone;

moving the optical projection mouse by a user fingertips in the optical projection mouse zone;

reflecting a new light path into the optical projection module by the fingertip when a light path emitted by the optical projection module passing the fingertip;

identifying the position of the key pressed by the fingertip and the moving distance of the fingertip by the optical projection module;

processing the data of the pressed key or the moving distance of the fingertip and identifying the position of the key pressed by the fingertip, the pressing frequency and the precise movement of the mouse by the optical projection module.

Further, pressing the optical projection keys by single finger or multiple fingers in the optical projection keyboard zone.

Further, the optical projection module includes a projector, an image collector and a processor;

generating an optical projection keyboard zone and an optical projection mouse zone by the projector;

emitting a light path to the user's fingertip by the laser device emits, reflecting the light path onto the image collector by the fingertip;

identifying the pressed position of the key in the optical projection keyboard zone by the image collector;

transferring the data of the pressed position to the processor by the image collector;

processing the data of the position pressed by the fingertips and identifying the position of the key and the pressing frequency by the processor.

Further, identifying the input position and the moving distance of the user's fingertip in the optical projection mouse zone by the image collector;

sending the movement data of the fingertip in the optical projection mouse zone to the processor by the image controller;

processing the movement data of the fingertip by the processor to achieve the precise movement of the mouse.

The optical projection keyboard zone and optical projection mouse zone can be operated independently or achieve the functions of keyboard inputting and mouse inputting synchronously.

### BRIEF DESCRIPTION OF THE DRAWINGS

FIG. 1 is an overall framework schematic diagram of the optical projection keyboard and mouse of the invention.

FIG. 2 is a constitutional diagram of the optical projection hardware module of the invention.

FIG. 3 is a schematic diagram of the input key position and identification of the optical projection keyboard zone of the invention.

FIG. 4 is a schematic diagram of the single-finger inputting and identification of the optical projection mouse zone of the invention.

FIG. 5 is a schematic diagram of the multi-finger inputting and identification of the optical projection mouse zone of the invention.

### DESCRIPTION OF THE PREFERRED EMBODIMENTS

The invention is further described in combination with Embodiments and Drawings as follows.

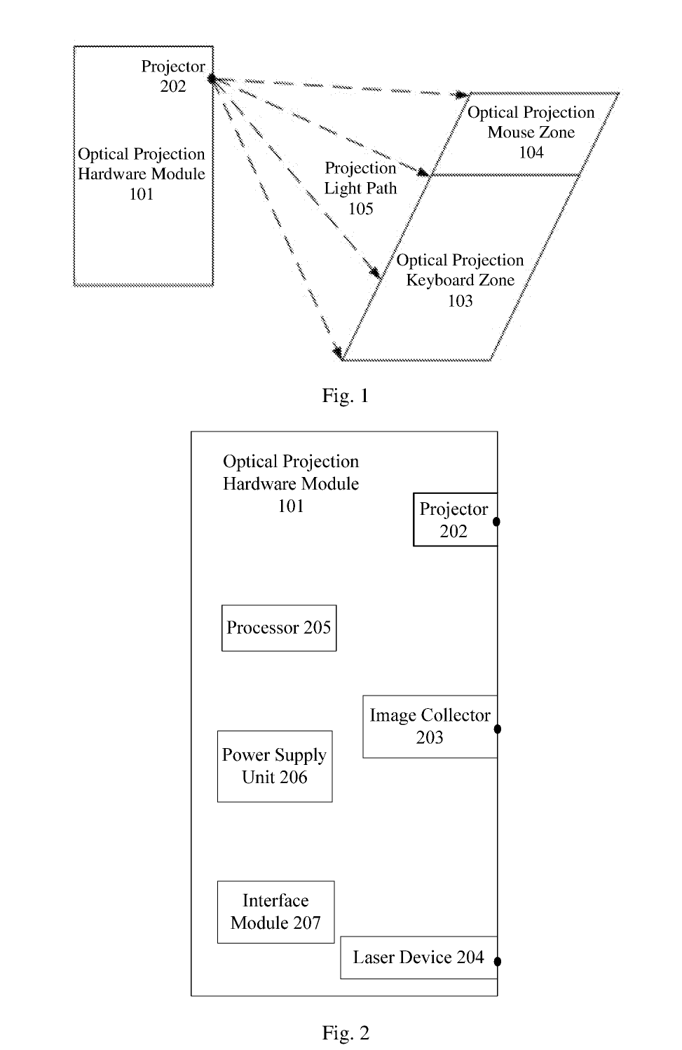

FIG. 1 is an overall framework schematic diagram of the optical projection keyboard and mouse, which comprises two parts as an optical projection hardware module 101 and an optical projection zone generated by the optical projection hardware module 101.

The optical projection zone comprises two parts as an optical projection keyboard zone 103 and an optical projection mouse zone 104.

The optical projection keyboard zone 103 and the optical projection mouse zone 104 are generated by a projection light path 105 of a projector 102.

FIG. 2 is a constitutional diagram of all parts of the optical projection hardware module of the invention. The optical projection hardware module 201 includes six parts as a projector 102, an image collector 203, a laser device 204, a processor 205, a power supply unit 206 and an interface module 207.

The projector 202 is adopted to generate a mouse zone and a keyboard zone that can be recognized by the user.

The image collector 203 can be a camera or a sensor, which is used for collecting the operating position of the user's fingertip.

The laser device 204 is adopted to emit an invisible light and the image collector 203 will identify the position and the moving distance of the fingertip through the reflected light of the fingertip.

The processor 205 is adopted to process relevant software algorithms; the power supply unit 206 can supply power to each part of the entire optical projection hardware module 201; the interface module 207 is adopted to provide interfaces for other devices or modules for connections.

The processor 205 uses an ARM chip, a SCM chip, a DSP chip, a FPGA chip, an Intel CPU chip or a programmable chip designed by the user.

The interface module 207 provides a USB port, a SPI port, a serial port, an I2C port, an EtherNET port or a communication interface between other modules.

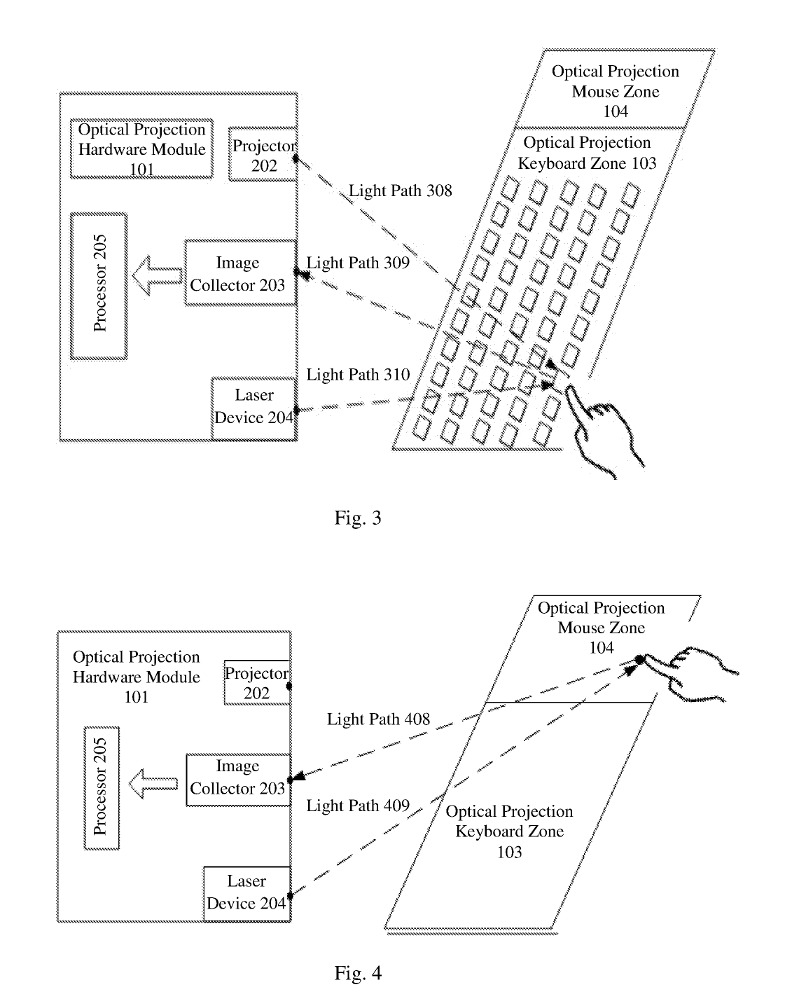

FIG. 3 is a schematic diagram of the input key position and identification of the optical projection keyboard zone of the invention. When an optical projection key is pressed by a finger in the optical projection keyboard zone 306, a light path 310 emitted by the laser device 204 will be reflected to generate a new light path 309 when passing the fingertip and then the image collector 203 identify the pressed position of the key. After the data of the position of the key pressed by the user is transferred to the processor 205 through the image collector 203, the processor 205 identifies the position of the key pressed by the user and the pressing frequency through software algorithms.

The operation of the user in the optical projection keyboard zone 103 is either key-pressing operation by single finger or typewriting operation by multiple fingers.

The optical projection keyboard zone 103 generates a regular alphabetical keyboard, a numeric keyboard, a shortcut keyboard of F* keys or a keyboard customized by the user.

FIG. 4 is a schematic diagram of the single-finger inputting and identification of the optical projection mouse zone of the invention. A user can control the mouse by moving the fingertip in the optical projection mouse zone 104. The laser device 204 emits a light path 409 to the fingertip and reflects a light path 408 to the image collector 203 so as to identify the input position and the accurate moving distance of the user's fingertip and further achieve the precise movement controlling of the mouse. The image collector 203 will send the finger movement data in the optical projection mouse zone 104 to the processor 205; the precise movement of the mouse then can be achieved through the algorithms in the processor 205.

In the optical projection mouse zone 104, a user can achieve the clicking function of the mouse by clicking with a fingertip, or achieve the right button function with two fingers or multiple fingers.

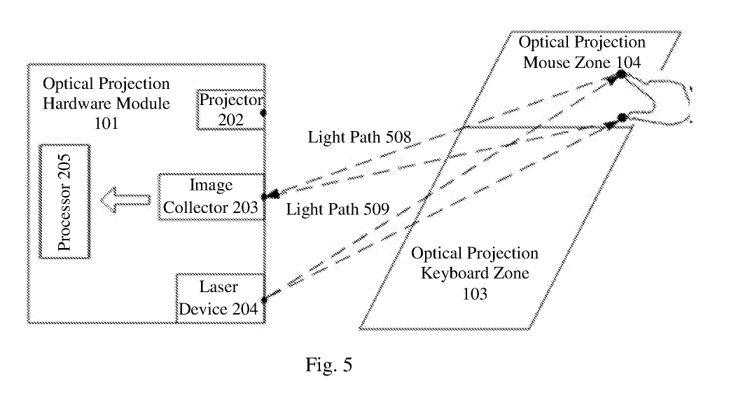

FIG. 5 is a schematic diagram of the multi-finger inputting and identification of the optical projection mouse zone of the invention. In the optical projection mouse zone 104, a user can operate with multiple fingers. For example, in the zooming-out operation of two fingers, the laser device 204 emits a light path 509 to each fingertip of the multiple fingers and reflects the position data and moving distance of the multiple fingers to the image collector 203 through a light path 508; the image collector 203 sends the data to the processor 205 and then the compound operation of the multi-fingers can be identified according to the software algorithm in the processor 205.

The multi-finger operation in the optical projection mouse zone is conducted with two fingers, three fingers or multiple fingers. The algorithm in the processor 205 can define the algorithmic functions coordinating the specific multi-finger operating tasks, such as zooming-in, zooming-out and task switching, etc.

The optical projection mouse zone and the optical projection keyboard zone in FIGS. 3, 4 and 5 can be operated independently or synchronously, i.e., the key position inputting, the mouse operation or the multi-finger task operation can be achieved independently, or the relevant mouse operation or multi-finger task operation can be conducted synchronously when the key position inputting is conducted.

The positions of the projector and the image collector shown in FIGS. 2, 3, 4 and 5 can be adjusted or interchanged as per specific design requirements.

The positions of the optical projection mouse zone and optical projection keyboard zone shown in FIGS. 1, 3, 4 and 5 can be interchangeable.

The above is only a further detailed description for the invention in combination with the specific preferred embodiments and the embodiments of the invention are not limited to it. For a person skilled in the art, the simple deductions or substitutions under the premise of not departing from the concept of the invention can be carried out, which will fall within the protection scope of the invention.

What is claimed is:

1. An optical projection keyboard and mouse, comprising:
an optical projection hardware module for generating an optical projection keyboard zone and an optical projection mouse zone;
an optical projection keyboard zone for achieving the functions of the keyboard;
an optical projection mouse zone for achieving the functions of the mouse;

2. The optical projection keyboard and mouse according to claim 1, wherein, a keyboard generated in the optical projection keyboard zone comprises a regular alphabetical keyboard, a numeric keyboard, a shortcut keyboard of F* keys or a customized keyboard.

3. The optical projection keyboard and mouse according to claim 1, wherein, a user can achieve the control function of the mouse by moving the fingertips in the optical projection mouse zone.

4. The optical projection keyboard and mouse according to claim 3, wherein, a user can achieve the control function of the mouse through multi-task operation with multiple fingers in the optical projection mouse zone.

5. The optical projection keyboard and mouse according to claim 1, wherein, the positions of the optical projection keyboard zone and the optical projection mouse zone are interchangeable.

6. The optical projection keyboard and mouse according to claim 2, wherein, a user can knock the keyboard to input in the optical projection keyboard zone and click the mouse to control in the optical projection mouse zone independently or synchronously.

7. The optical projection keyboard and mouse according to claim 3, wherein, a user can knock the keyboard to input in the optical projection keyboard zone and click the mouse to control in the optical projection mouse zone independently or synchronously.

8. The optical projection keyboard and mouse according to claim 1, wherein, the optical projection hardware module comprises:
a projector for generating the optical projection keyboard zone and the mouse zone;
a laser device for emitting invisible light to the operating fingertip of the user;
an image collector for receiving the reflected light of the operating fingertip of the user and collecting the operating position of the fingertip of the user;
a processor for receiving the data transferred by the image collector and processing and identifying the data;
a power supply unit for supplying power to each module in the optical projection hardware module;
an interface module for achieving connections with other modules.

9. The optical projection keyboard and mouse according to claim 8, wherein, the image collector is a camera or a sensor.

10. The optical projection keyboard and mouse according to claim 8, wherein, the processor is an ARM chip, a SCM chip, a DSP chip, a FPGA chip, an Intel CPU chip or a self-designed programmable chip.

11. The optical projection keyboard and mouse according to claim 8, wherein, the interface module provides a USB port, a SPI port, a serial port, an I2C port or an Ethernet port.

12. The optical projection keyboard and mouse according to claim 1, wherein, the optical projection hardware module is to achieve the functions of the optical projection keyboard and mouse through operating independently or being embedded into other devices.

13. A method for using the optical projection keyboard and mouse, the method comprising:
generating an optical projection keyboard zone and an optical projection mouse zone by an optical projection module;
pressing the optical projection keys by a user fingertips in the optical projection keyboard zone;
moving the optical projection mouse by a user fingertips in the optical projection mouse zone;
reflecting a new light path into the optical projection module by the fingertip when a light path emitted by the optical projection module passing the fingertip;
identifying the position of the key pressed by the fingertip and the moving distance of the fingertip by the optical projection module;
processing the data of the pressed key or the moving distance of the fingertip and identifying the position of the key pressed by the fingertip, the pressing frequency and the precise movement of the mouse by the optical projection module.

14. The method for using the optical projection keyboard and mouse according to claim 13, comprising:
pressing the optical projection keys by single finger or multiple fingers in the optical projection keyboard zone.

15. The method for using the optical projection keyboard and mouse according to claim 13, comprising:
generating an optical projection keyboard zone and an optical projection mouse zone by the projector;
emitting a light path to the user's fingertip by the laser device emits, reflecting the light path onto the image collector by the fingertip;
identifying the pressed position of the key in the optical projection keyboard zone by the image collector;
transferring the data of the pressed position to the processor by the image collector;
processing the data of the position pressed by the fingertips and identifying the position of the key and the pressing frequency by the processor.

16. The method for using the optical projection keyboard and mouse according to claim 13, comprising:
identifying the input position and the moving distance of the user's fingertip in the optical projection mouse zone by the image collector;
sending the movement data of the fingertip in the optical projection mouse zone to the processor by the image controller;
processing the movement data of the fingertip by the processor to achieve the precise movement of the mouse.
